(19) United States
(12) Patent Application Publication
(10) Pub. No.: US 2009/0282715 A1
(43) Pub. Date: Nov. 19, 2009

(54) Signage apparatus having simple magnet-based structure for ease of modification

(76) Inventor: Kirk Pemberton, Gardena, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 12/460,546

(22) Filed: Jul. 21, 2009

Related U.S. Application Data
(63) Continuation-in-part of application No. 11/653,063, filed on Jan. 12, 2007.

(51) Int. Cl. G09F 13/04; G09F 7/04

(52) U.S. Cl. 40/564

(57) ABSTRACT

A readily modifiable modular sign apparatus is especially useful for fast food restaurants as backlighted menu boards in both indoor and outdoor applications. The apparatus comprises a preferably translucent substrate or mounting board which is preferably planar and has a front surface and a back surface. Precisely positioned holes are prepared at selected locations. These holes are formed to be aligned with thin metal shims which are affixed on the back surface of the mounting board and receive cylindrical magnets on the front surface. The magnets are attached directly to the rear of printed sheets, each of which may have wording or pictorial information or both. The magnets contact the metal shims through the mounting board holes, and are held firmly in position by virtue of both the magnetic attractive force and the shape of the walls of the mounting board holes. This magnet-based structure is also employed in an inclined menu board application. Graphics-bearing printed sheets are magnetically attached to rigid transparent plastic support structures. In one embodiment magnets affixed to the front of the sheets are attracted to metal shims on the upper surface of the plastic support structures. The support structure is inclined downwardly so that a customer located below an elevated menu board has a line of sight which is substantially normal to the printed sheets.

### CROSS-REFERENCE TO RELATED APPLICATIONS

This application is a continuation-in-part of patent application Ser. No. 11/653,063 filed on Jan. 12, 2007.

### BACKGROUND OF THE INVENTION

1. Field of the Invention

The present invention relates generally to signs of the type used in fast food restaurants, coffee shops and other retail stores where items offered for sale and their prices frequently change. More specifically, the invention herein relates to a readily modifiable menu board or similar sign which employs a relatively simple magnet-based structure to facilitate easy modifications by non-technical personnel.

2. Background Art

Modular panel signs are most commonly found in fast food restaurants for display of their food menu in both outdoor and indoor applications. Such signs are usually backlighted and often contain verbal and graphical descriptions of food items and their respective retail prices. One of the key attributes of such menu signs is that they're usually the best and often the only source of menu information for the retail consumer in the restaurant or in the drive-through lane of the restaurant. Therefore, such signs are of critical importance to the successful operation of the restaurant. Their price information is very important as is their graphics which may both provide information about and entice the prospective fast food consumer to purchase a particular food item based on its visual appearance. A common characteristic of restaurants and other food-oriented retail establishments, particularly fast food stores, is that their menu changes often. Either the food items or the respective prices for food items or both, will change frequently to accommodate new offerings, delete less popular items and reflect virtually constantly revised prices to respond to competition or to comport with media advertising. For this reason, it is important that signs are relatively easy to update frequently and that signs can be modified by unsophisticated personnel without requiring elaborate and expensive training.

Issued U.S. Pat. Nos. 6,003,258 and 6,282,825 to Godfrey et al disclose one prior art sign assembly which addresses the need for a menu board type display which can be modified to other content including price information. The sign assembly of the Godfrey et al patents comprises a frame design having distinct front and rear portions as shown, for example, in their FIG. 6. The rear portion comprises a frame and the front portion comprises a mechanically mating transparent cover panel which holds a plastic sheet and a sign element which has graphics printed thereon. The cover panel uses magnetic strips to adhere to the frame at mating metallic strips which are adhesively secured to the frame at matching locations. Separate retention members and stop elements are employed to prevent the sign from sliding out of position. The sign element may be in the form of elongated strips as shown in their FIG. 21. Each such strip is disclosed as having a front piece and a back piece. The front piece has a number of rectangular windows and the back piece has a corresponding number of aligned price pockets for holding inserted numerical indicia for displaying price information through the windows of the front piece. The front piece also has alphanumeric characters which may be printed thereon.

Another readily modified sign assembly for similar applications is disclosed in U.S. Pat. No. 6,182,387 to Duguay. This patent discloses a sign assembly having a magnetically attractable uniform surface completely covered by individual magnetic strips and price elements. Each such strip or element comprises a solid front surface bearing printed indicia and a magnet or magnetic strip affixed to the rear of the front surface. The magnet covers only a portion of the rear of the front surface so that a fulcrum point is formed to permit removal and replacement of the element or strip without special tools. A problem with such a sign assembly is that such a large plurality of separate sign elements do not provide a uniform and professional-looking appearance. Additionally, even with relatively strong magnets, the individual elements would tend to slide off of their intended positions.

Although the prior art disclosures address the need for a sign assembly that can be modified to accommodate frequent changes in food items and their respective prices, there are a number of disadvantages which remain. For example, the number of steps required to change a display are still greater than is desired. The structural complexity of the assembly is still higher than is preferred. The use of a frame of a particular size would make it disadvantageous to change the dimensions of the preferred sign graphics. The use of price pockets on a back piece that need to extend through aligned windows on a front piece, put undesirable constraints on the dimensions and manufacture of the signs and make the price pocket concept unnecessarily complex. The need for locking or stop elements to prevent sliding movement of the printed sign element within the assembled frame is also a disadvantage because it adds to the parts count and cost of the assembly. Moreover, a sign having a large number of individual magnetic pieces does not present a professional finished appearance.

Therefore, there is still an unresolved need for a readily modified signage apparatus which overcomes the noted deficiencies of the prior art. More specifically, it would be highly advantageous if there were a sign assembly which did not require a frame structure, which did not need separate locking or stop elements, which did not utilize separate front and back pieces for price pockets, which was of even simpler structure, which required even fewer steps to change sign content and which still provided a neat, finished and professional looking appearance.

### SUMMARY OF THE INVENTION

The present invention, in its preferred embodiment, provides a simple and advantageous solution for the previously unresolved need for a readily modifiable modular sign apparatus that is especially useful for fast food restaurants as backlighted menu boards in both indoor and outdoor applications. The apparatus comprises a preferably translucent substrate or mounting board which may be made of an acrylic or other rigid material including, for example, polycarbonate or styrene. The mounting board is preferably planar and has a front surface and a back surface and in a preferred embodiment is about 5 mm in thickness. Precisely positioned holes are prepared at selected locations. These holes are formed to be aligned with thin metal shims which are affixed on the back surface of the mounting board and receive cylindrical magnets on the front surface. The magnets are attached directly to the rear of printed sheets, each of which may have wording or pictorial information or both. The magnets contact the metal shims through the mounting board holes, and are held firmly in position by virtue of both the magnetic attractive force and the shape of the walls of the mounting board holes. The mounting board holes are preferably beveled toward the front surface of the board to make it easier to locate the magnets accurately and to remove them when it is desired to replace the printed sheet.

The printed sheets have precise, selected dimensions to fill a desired space on the substrate or mounting board, while at the same time, having one or more edges which closely align with one or more corresponding edges or borders of the mounting board. For example, where a printed sheet is rectangular in shape, its upper edge may be substantially congruent to the upper edge of the mounting board. This alignment precision is dependent on the location of the holes and metal shims on the mounting board and on the accuracy of placement of the magnets that are affixed on the back surface of the printed sheets.

Changing the content of a sign of the present invention, involves the simple steps of removing a sheet by pulling the sheet and its adhered magnets away the mounting board and replacing it with another printed sheet having magnets which mate with the mounting board holes. Border or edge members made of plastic or other inexpensive materials, may be preferably used between adjacent printed sheets to provide a neat finished appearance. Such border members may be secured to the mounting board using holes and metal shims and adhered magnets in the same manner as the printed sheets are secured.

The printed sheets may be provided with price carriers to permit personnel to change just food prices without the requirement to replace the entire printed sheet. In the preferred embodiment of the present invention, such price carriers are affixed directly to the front surface of the printed sheets in a unitary, integrated structure that provides easy access to the price indicia.

The mounting board may be provided with a large number of extra holes with affixed metal shims so that the size and shape of the printed sheets may be altered as well, by simply adjusting the locations of the affixed magnets on the replacement sheets. This feature provides the added flexibility of changing the module geometry of a modular sign assembly without replacing the mounting board.

An improved version of the present invention is shown herein for use in inclined menu boards which are sometimes used in fast food restaurants and other retail establishments to improve the visibility and legibility of elevated signs. Such signs or menu boards are inclined downwardly at a selected angle so that customers positioned below the signs or menu boards may have a line of sight which is substantially normal or perpendicular to the graphics displayed thereon. The inventive embodiment shown herein, provides a rigid transparent plastic or glass face to which a graphics sheet is magnetically affixed in the manner taught herein. In this way, the rigid face and printed sheet form the inclined surface of a light box or translucent back-lighted board with at least one magnet assembly securing the printed sheet in proper alignment with the rigid transparent face. The use of magnet-based attachment permits simple and fast replacement of the printed sheets.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional view of a fast food outdoor modular, backlighted sign display in which a preferred embodiment of the invention is employed;

FIG. 2 is a partially exploded view of the sign display of FIG. 1;

FIG. 3 is a further enlarged and exploded view of a selected module of the sign display of FIG. 1;

FIG. 4, comprising FIGS. 4A, 4B and 4C, is a still further enlarged view of a portion of a selected module of the sign display of FIG. 3;

FIG. 5, comprising FIGS. 5A, 5B and 5C, is a view of an edge member used in the preferred embodiment;

FIG. 6, comprising FIGS. 6A, 6B and 6C, is a view of a price carrier construction of the preferred embodiment;

FIG. 7 is an exploded view of the price carrier of FIG. 6;

FIG. 8 is a plan view of a mounting board assembly of the sign display of FIG. 1;

FIG. 9 is a conceptual side view of an inclined sign or menu board employing another magnet-based embodiment of the present invention;

FIG. 10 is a front view of the sign or menu board of FIG. 9;

FIG. 11 is a top view of the embodiment of FIG. 10 with the printed sheet shown separated from the rigid transparent face;

FIG. 12 is a top view similar to that of FIG. 11, but showing the printed sheet attached to the rigid transparent face by the magnetic assembly hereof; and

FIG. 13 is an enlarged view showing the magnetic assembly of the inclined sign or menu board embodiment of the present invention.

### DETAILED DESCRIPTION OF A PREFERRED EMBODIMENT

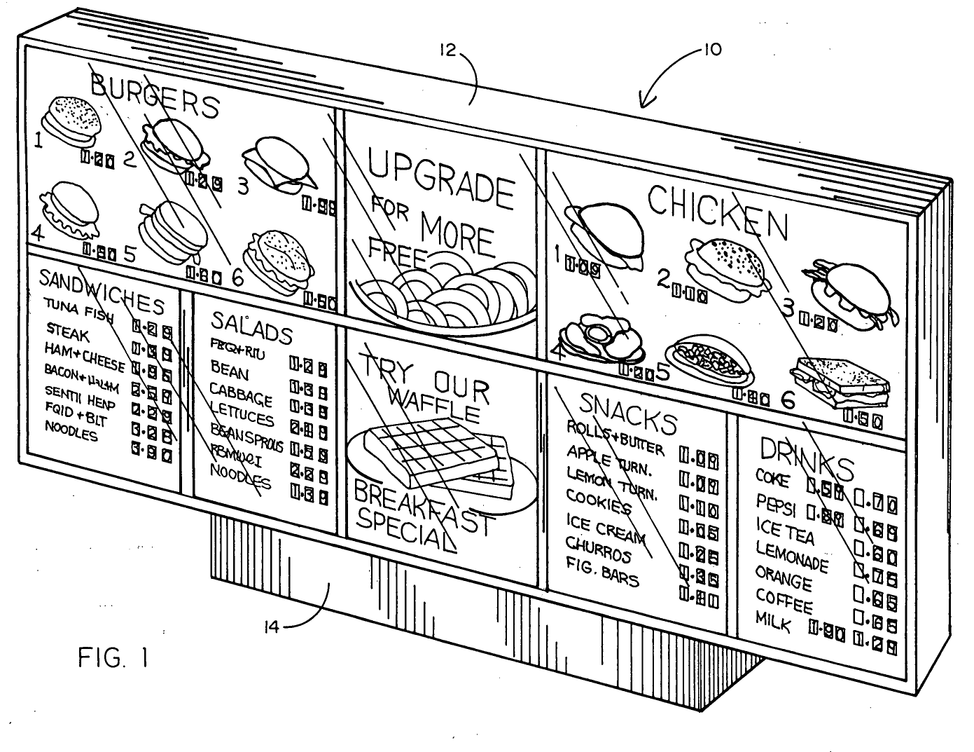

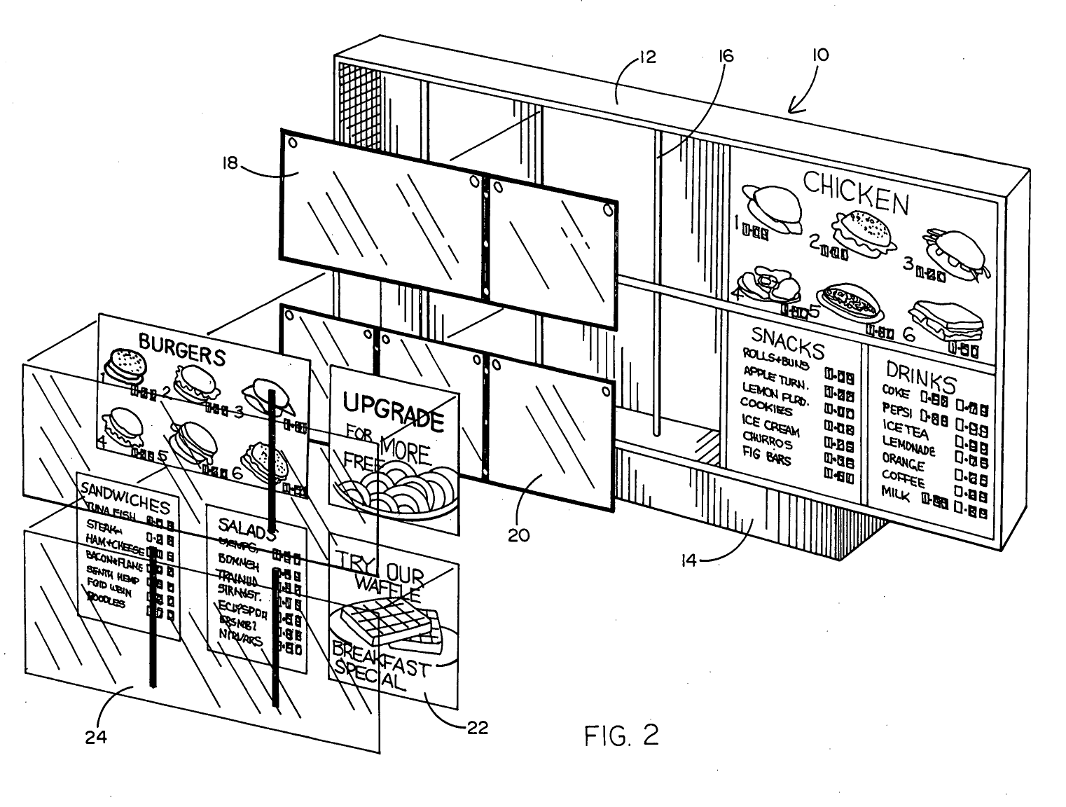

Referring to the accompanying drawings and initially to FIGS. 1-3, it will be seen that a modular display 10 comprises a rectangular enclosure 12 resting on a base 14. The enclosure 12 has a plurality of backlights 16 in the form of vertical fluorescent tubes. A plurality of rectangular mounting boards 18, 19, 20 and 21 are positioned in front of the backlights 16. Each such mounting board is covered by one or more printed sheets 22. A transparent hard plastic protective cover 24 overlies the printed sheets. Between each pair of adjacent printed sheets 22 is an edge member 27.

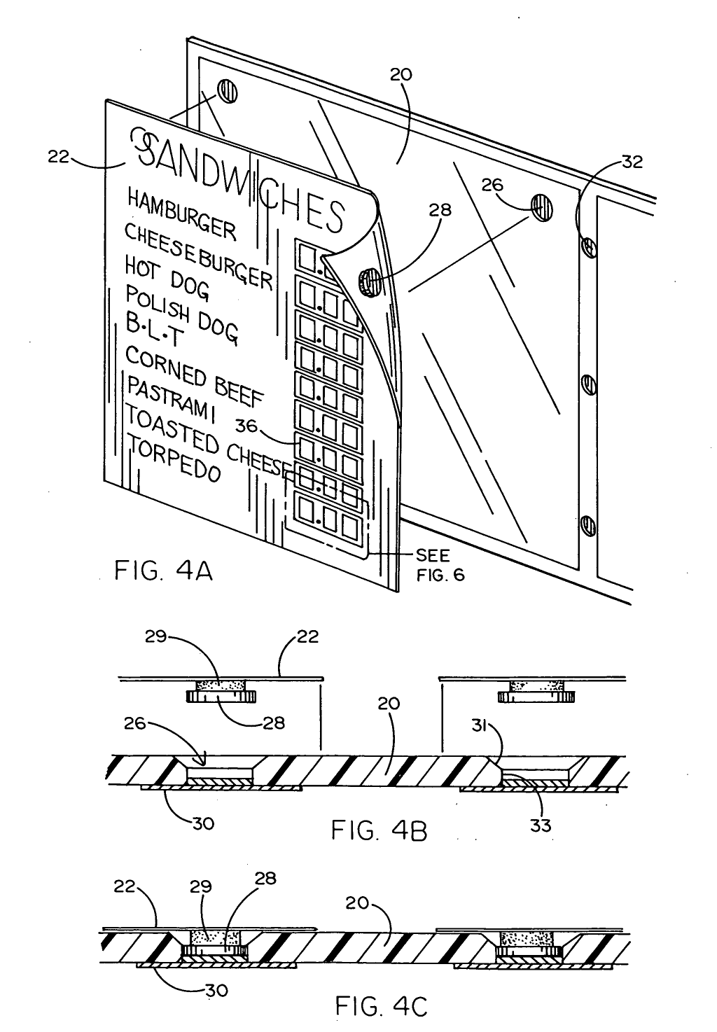

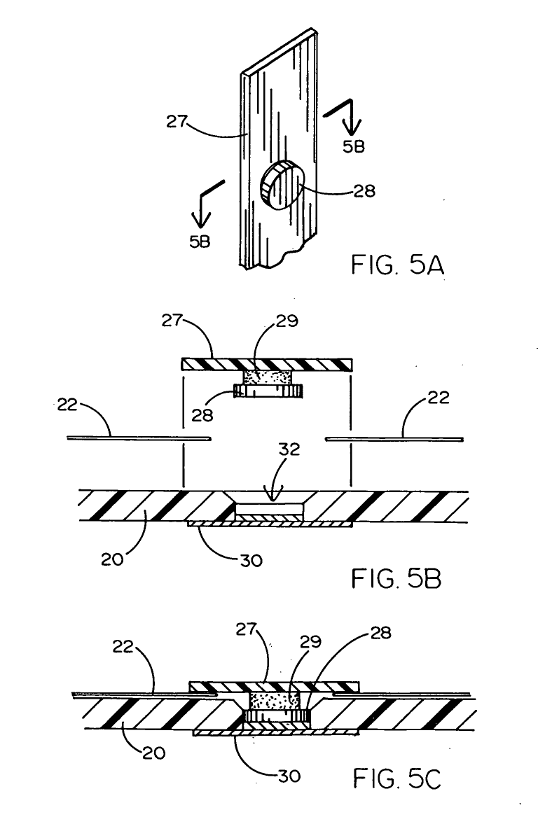

The manner in which the printed sheets and edge members are secured to the mounting board is shown in FIGS. 4 and 5. Referring first to FIG. 4, it will be seen that each printed sheet 22 is attached to the mounting board at a pair of apertures 26 using a corresponding pair of flat cylindrical magnets 28. Each such magnet is adhesively affixed to a sponge-like material 29 which is, in turn, glued to the back of the printed sheet 22 at precisely selected locations. As shown best in FIGS. 4B and 4C, the back surface of the mounting board has a round metal shim 30 aligned with each aperture 26 and adhered to the mounting board surface. Each such aperture 26 has a beveled front portion 31 and straight-walled portion 33. The magnets 28, each extend through the beveled portion 31 and rest in the straight-walled portion 33 where it contacts the metal shim 30.

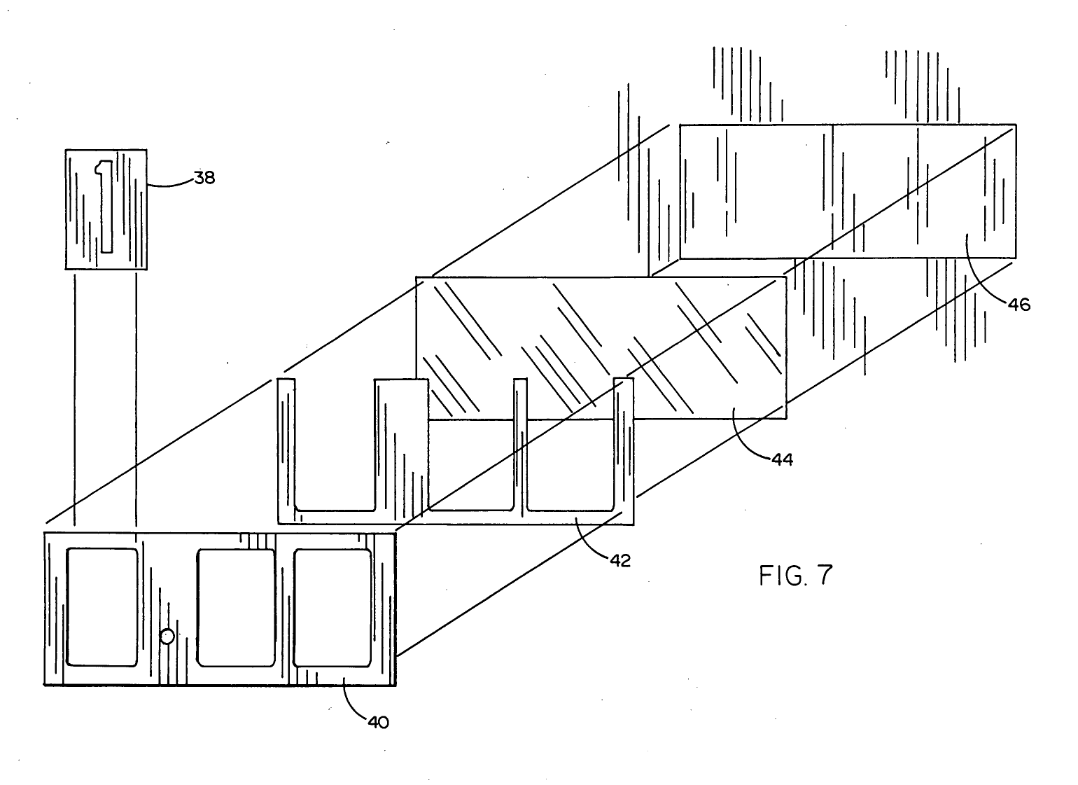

As shown in FIGS. 5A, 5B and 5C, each edge member 27 is connected using a plurality of the magnets 28 in mounting board apertures 32. Each such aperture 32 has the same structure (i.e. partially beveled, partially straight) as the aperture 26 and also terminates in a round metal shim 30. The edge members 27 preferably overlap the adjacent edges of two sheets 22 to provide a finished, neat look to the display. The relative positions of the mounting boards 18, 19, 20 and 21 and their respective apertures 26 and 32 are shown in FIG. 8 for the entire modular display 10.

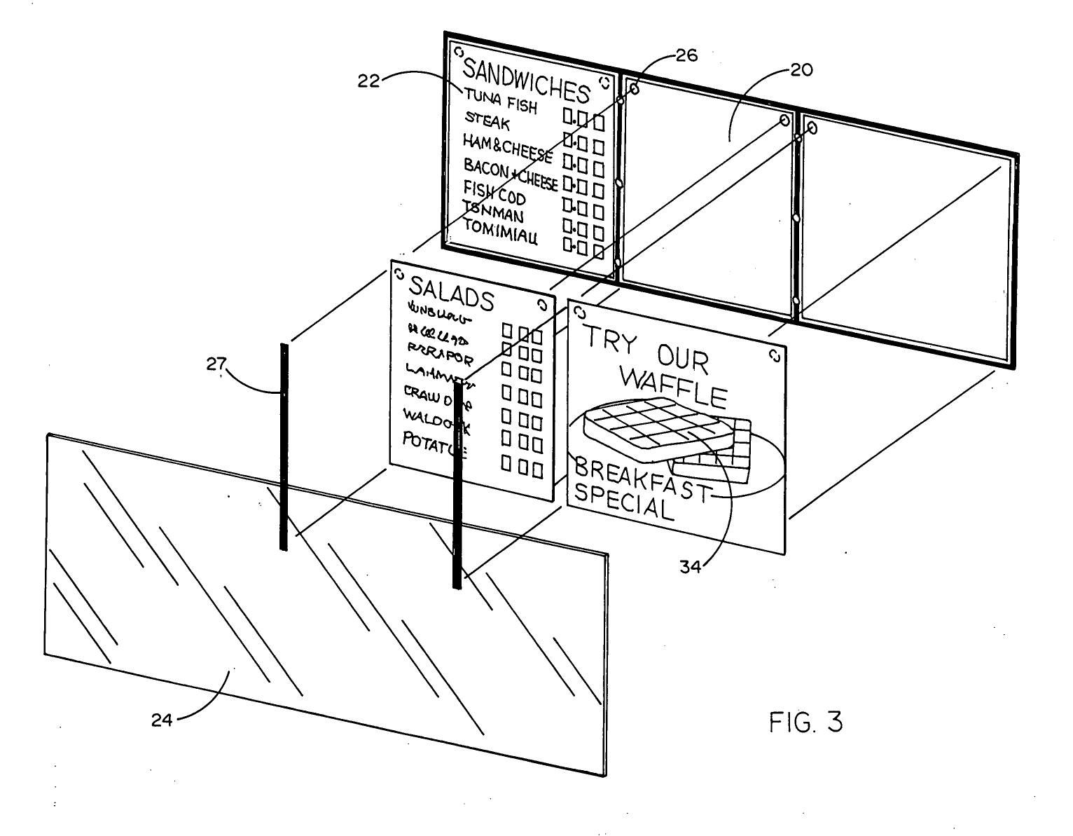

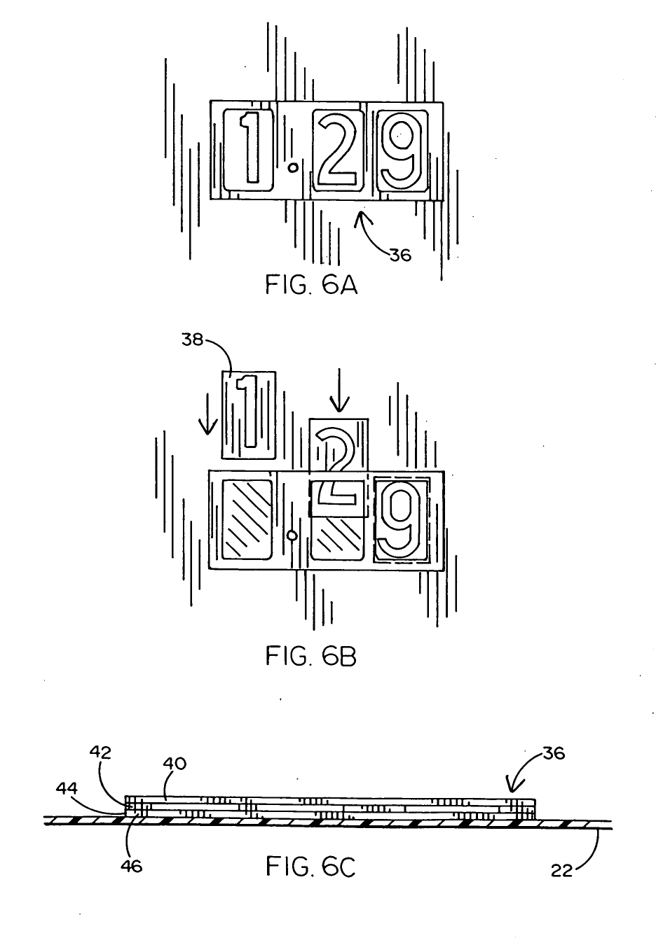

As seen in FIGS. 3 and 4A, some of the printed sheets 22 may have graphics 34 and/or wording 35 as well as price carriers 36. Price carriers permit price changes to be made without replacing the sheets. Their structure is shown in FIGS. 6A, 6B, 6C and 7. As shown in those figures, a price carrier 36 according to a preferred embodiment of the present invention, comprises at least one number sheet 38, a window member 40, a number sheet holder 42, a slip member 44 and a backing 46. These constituent parts are adhesively assembled as shown in FIG. 7 and then secured to the front surface of a printed sheet 22 as shown in FIG. 6C. The number sheets 38, reflecting the current price of a product, are then inserted as shown in FIG. 6B to provide a selected price as shown in FIG. 6A.

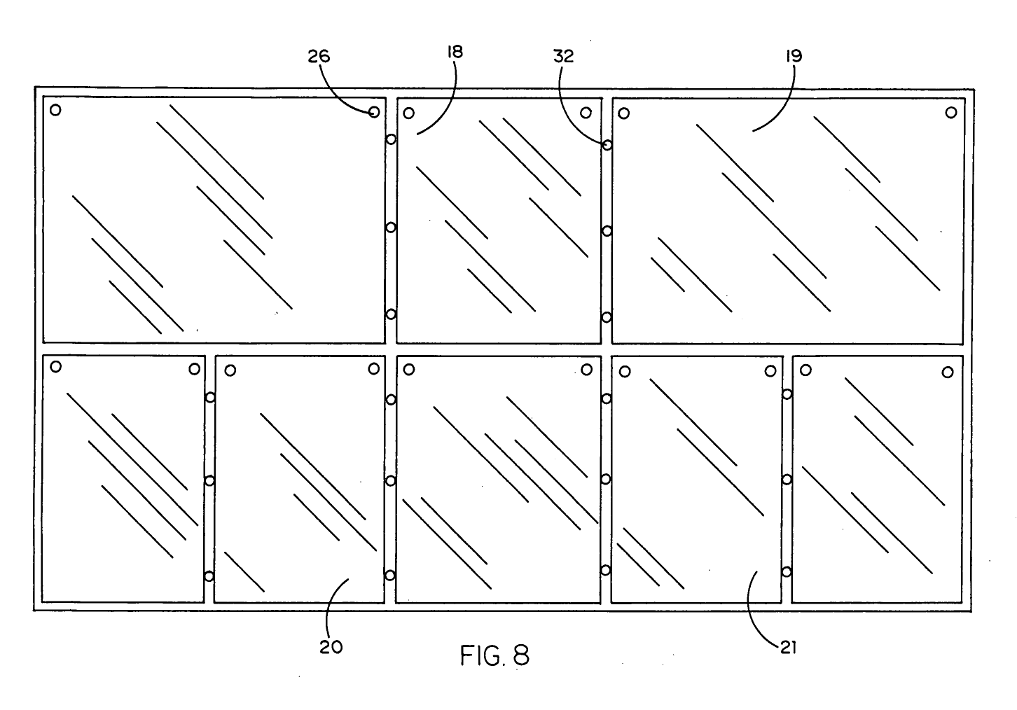

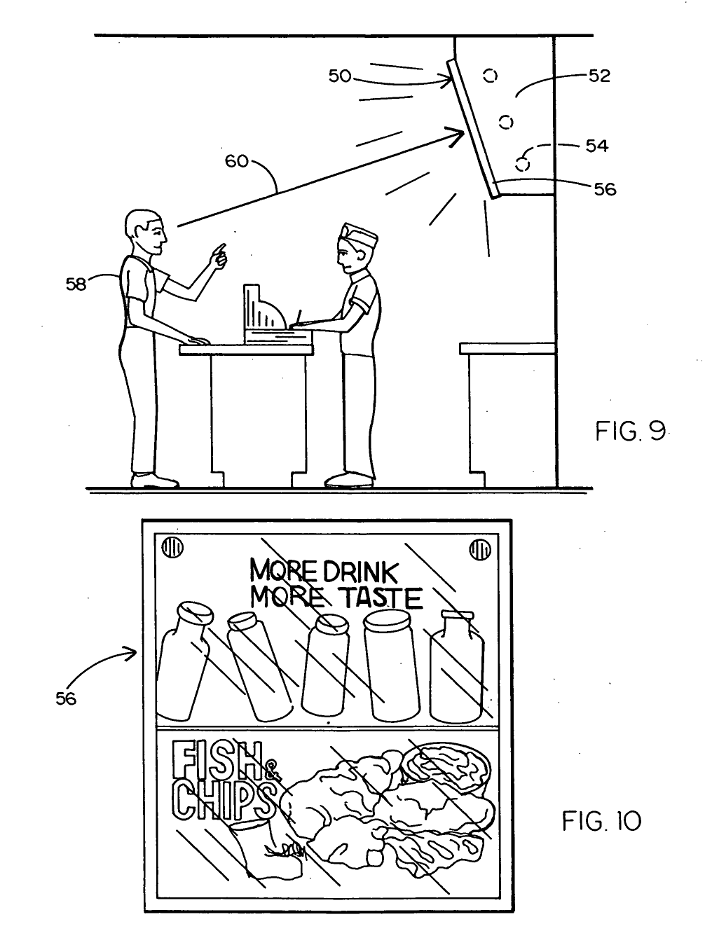

An embodiment of the present invention designed for use in an inclined sign or menu board, is shown in FIGS. 9 to 13 to which reference will now be made. As shown in FIG. 9, an inclined menu board 50 is formed from a wall or ceiling mounted light box 52 which may, for example, have a plurality of light source bulbs 54 to provide a brightly backlit configuration for a graphics presentation 56. Presentation 56 is inclined at a selected angle so that a customer 58 who is at a position that is generally below the sign or menu board 50, may have a substantially normal or perpendicular line of sight as represented by arrow 60. FIG. 10 illustrates an example of the type of printed graphics in a presentation 56.

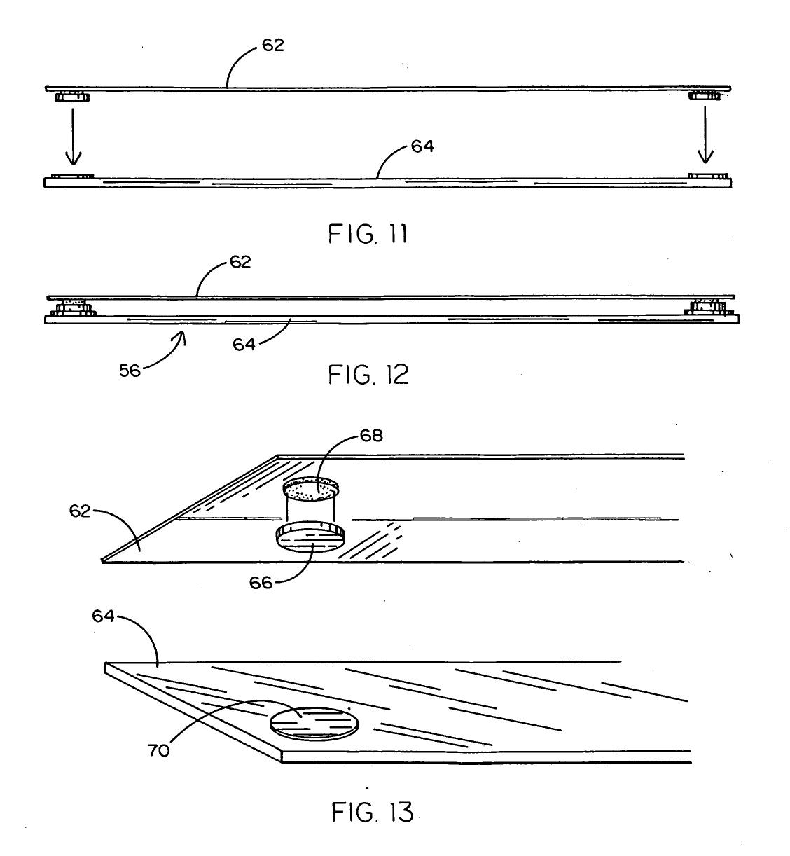

Referring now to FIGS. 11-13, it will be seen that menu board presentation 56 comprises a printed graphics sheet 62 and a rigid transparent face 64. The rigid transparent face 64 is preferably made of a rigid plastic and is sufficiently thick so that it is structurally stable in an inclined position, while still being sufficiently light to be easily supported by a simple frame-like structure (not shown) on the front of light box 52. Light boxes of this type are well known in the fast food restaurant industry and therefore need not be described herein in more detail. Suffice it to say that a printed graphics sheet 62 needs to be affixed to the inner surface of rigid transparent face 64 in a way which keeps the sheet flat and precisely positioned so that customer 58 can readily observe the graphics thereof with little or no visual obstruction despite the angle of incline of the menu board 56. This is accomplished in the illustrated embodiment using a magnetic assembly comprising a magnet 66 and a magnetic-type metal shim or disc 70. Magnet 66 is preferably affixed adhesively to the front surface of graphics sheet 62 using interposed sponge-like intermediate member 68 (see FIG. 113) which is adhesively affixed both to the sheet front surface and to the magnet. Shim 70 is preferably adhered to the back or upper surface of face 64 at a location which is aligned with magnet 66 so that the graphics sheet 62 lies flat and positioned precisely to make the menu board easy to read and aesthetically pleasing. Yet one may readily remove and replace the graphic sheet at any time.

Having thus disclosed a preferred embodiment of the invention, it will now be understood that various modifications may be made while still utilizing the novel features thereof. By way of example, the precise size, position and shape of printed sheets may be modified. Moreover, the location, shape and number of magnets used to secure the printed sheets to a rigid transparent face may be modified. Furthermore, magnets and metal shims may be interchangeable. Therefore, it will be understood that the scope hereof is not limited by the disclosed preferred embodiment, but only by the appended claims and their equivalents.

I claim:

1. A signage apparatus comprising:
a light box configured for installation at an elevated location and having an inclined surface containing information to be viewed by an observer below said elevated location;
said inclined surface being formed by a rigid transparent face that is oriented to provide a substantially normal line of sight to said observer;
a printed sheet having observable indicia thereon providing said information and having at least one magnet affixed to a front surface of said printed sheet at a selected location thereon;
said rigid transparent face having a metal member positioned on an inner surface of said face within said light box, said inner surface receiving said printed sheet with said magnet aligned with said metal member for releasibly securing said sheet to said face.

2. The signage apparatus recited in claim 1 wherein said rigid transparent face is made of plastic.

3. The signage apparatus recited in claim 1 wherein said rigid transparent face is made of glass.

4. The signage apparatus recited in claim 1 wherein said magnet is adhesively affixed to said printed sheet.

5. The signage apparatus recited in claim 4 wherein said printed sheet further comprises a sponge-like material interposed between said magnet and said observable indicia.

6. A signage apparatus comprising:
a light box configured for installation at an elevated location and having an inclined surface containing information to be viewed by an observer below said elevated location;
said inclined surface being formed by a rigid transparent face that is oriented to provide a substantially normal line of sight to said observer;
a printed sheet having observable indicia thereon providing said information and having at least one first magnetic device affixed to a front surface of said printed sheet at a selected location thereon;
said rigid transparent face having a second magnetic device positioned on an inner surface of said face within said light box, said inner surface receiving said printed sheet with said first magnetic device aligned with said second magnetic device for releasibly securing said sheet to said face.

7. The signage apparatus recited in claim 6 wherein said rigid transparent face is made of plastic.

8. The signage apparatus recited in claim 6 wherein said rigid transparent face is made of glass.

9. The signage apparatus recited in claim 6 wherein said first magnetic device is adhesively affixed to said printed sheet.

10. The signage apparatus recited in claim 9 wherein said printed sheet further comprises a sponge-like material interposed between said first magnetic device and said observable indicia.
